(19) United States
(12) Patent Application Publication
(10) Pub. No.: US 2013/0231782 A1
(43) Pub. Date: Sep. 5, 2013

(54) INTEGRATED MONITORING AND CONTROLLING OF VARIOUS CITY FUNCTIONALITIES

(71) Applicant: LG CNS CO., LTD., Seoul (KR)

(72) Inventors: Jeong Hwan Lee, Seoul (KR); Hwan Ki Yu, Seoul (KR); Jun-Ho Moon, Gyeonggi-do (KR); Kyung Hwa Yang, Seoul (KR)

(73) Assignee: LG CNS CO., LTD., Seoul (KR)

(21) Appl. No.: 13/776,780

(22) Filed: Feb. 26, 2013

(30) Foreign Application Priority Data
Mar. 2, 2012 (KR) 10-2012-0021904

(51) Int. Cl. G05B 15/02

(52) U.S. Cl. CPC G05B 15/02
USPC 700/275

(57) ABSTRACT

Embodiments of the present invention generally relate to communications systems and methods for monitoring and/or controlling a multitude of functionalities within various facilities and/or buildings. More particularly, the present invention relates to communications systems and methods for remotely monitoring and/or controlling a plurality of site functionalities relating to various utility, security, maintenance, etc., systems within a town or city.

### CROSS-REFERENCE TO RELATED APPLICATION

This application claims priority under 35 U.S.C §119 to Korean Patent Application No. 10-2012-0021904, filed on Mar. 2, 2012 in the Korean Intellectual Property Office, the contents of which is incorporated herein by reference.

### TECHNICAL FIELD

In general, embodiments of the present invention relate to distributed facility management and operational control. More particularly, the present invention relates to communications systems and methods for remotely monitoring and/or controlling a plurality of site functionalities within a town or city.

### BACKGROUND

The last couple of decades have witnessed a revolution in electronic connectivity and communication technology. Technology has proceeded from a point where simple, stand-alone computer systems performed the majority of computational and control tasks to the present day, where modern systems and techniques have enabled the establishment of control and communication network systems.

Today's buildings, whether residential, commercial, medical, or otherwise, are sustained through operation of various utility systems. Through operation of such systems, electricity, heat, HVAC, water, lighting, security, and other necessities are typically provided to the buildings. Each system may include various electrical, mechanical, and human components that ensure proper operation of such system. Some conventional systems are controlled by human operators and. thus, require maintenance of staff on-site or on-call to control, maintain, and otherwise operate the systems. Others may be controlled automatically or through a combination of automatic and human control. Such systems force building owners to extend additional resources and costs in order to maintain proper operation of these systems, as well as account for any human errors that may result in improper operation of the systems. This may be costly, as one overlooked system malfunction can lead to a whole host of problems that will need to be fixed.

Further, many conventional systems are not capable of remotely controlling multiple buildings having multiple building functionalities using a single monitor-and-control device and be adaptable to various control interfaces that are used by the buildings and building owners.

Thus, there is a need to provide a system and a method for remotely monitoring and controlling various functionalities within a facility/building and/or facilities/buildings in a unified control system, where such monitoring and control functions are configured to be adaptable to various system and/or building environments. Heretofore, several unsuccessful attempts have been made to address these shortcomings.

U.S. Pat. No. 6,917,859 discloses a facility management system and method for maintaining and inspecting electric facilities such as an air conditioning system installed in a building.

U.S. Patent Application 20100274366 discloses a system and method for controlling and monitoring a system within a facility.

U.S. Pat. No. 7,427,916 discloses a method for performing maintenance inspection and monitoring of various structures and facilities by arranging a sensor on a moving portion of the facility of a building or a portion where wiring is difficult.

U.S. Pat. No. 7,280,877 discloses a facility control monitoring method and a facility control monitoring apparatus for monitoring control of facilities that operate devices to be controlled, such as air conditioners.

U.S. Patent Application 2011/0190943 discloses a system and method for controlling one or more facilities based on one or more operating logic parameters.

None of these references, however, teach a method for remotely monitoring and controlling various functionalities within a facility/building and/or facilities/buildings in a unified control system, where such monitoring and control functions are configured to be adaptable to various system and/or building environments.

### SUMMARY

In general, embodiments of the present invention relate to communications systems and methods for monitoring and/or controlling a multitude of functionalities within various facilities and/or buildings. More particularly, the present invention relates to communications systems and methods for remotely monitoring and/or controlling a plurality of site functionalities relating to various utility, security, maintenance, etc., systems within a town or city.

A first aspect of the present invention provides a computer-implemented method for monitoring and controlling a plurality of city functionalities, comprising: monitoring a first status of a first functionality at a first site; monitoring a second status of a second functionality at a second site; determining an event based on one of the first or second status; determining a categorization of the event; and performing a service in response to the categorization of the event.

A second aspect of the present invention provides a unified system for monitoring and controlling a plurality of city functionalities, comprising: a monitoring module configured to monitor a first status of a first functionality at a first site; the monitoring module further configured to monitor a second status of a second functionality at a second site; an event module configured to determine an event based on one of the first or second status; the event module further configured to determine a categorization of the event; and a service module configured to perform a service in response to the categorization of the event.

A third aspect of the present invention provides a computer program product for monitoring and controlling a plurality of city functionalities, the computer program product comprising a computer readable storage media, and program instructions stored on the computer readable storage media, to: monitor a first status of a first functionality at a first site; monitor a second status of a second functionality at a second site; determine an event based on one of the first or second status; determine a categorization of the event; and perform a service in response to the categorization of the event.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative unified city building control system in which various aspects of the invention may be implemented.

FIG. 2 shows a high-level diagram of an illustrative unified control system in which various aspects of the invention may be implemented.

FIG. 3 shows an illustrative middleware module operating with various components of the invention.

FIG. 4 shows a detailed graphical illustration according to an embodiment of the present invention showing a monitoring/controlling process.

FIG. 5 shows four illustrative communications layers which provide information flow between a web client and a communication module.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In the following description, the terms “building” and “facility” (along with their plural counterparts) will be used interchangeably and as can be understood by one having ordinary skill in the art, will be given their broadest possible interpretation. For example, a building can be a single-story one room facility or a multi-story multi-floor multi-room facility (and vice versa). Each such facility may have a single or multiple systems and subsystems that are configured to provide various functionality and/or functionalities that are used by the building(s). Additionally, the term “site” refers to any location, facility, building, building structure, equipment, equipment component, or the like.

As used herein, the term “module” refers to a set of hardware and/or software in a computing system that performs a particular function. The terms “processor” and “module” are used synonymously herein. For example, a display module in a conventional desktop computer may include the computer's CPU, graphics card, video memory, monitor, and portions of the operating system that process display information. Examples of other modules include processing modules, input modules, and power modules. A module may be embodied in hardware, software, data and/or instruction streams, and any combination thereof. A single physical device in a computer system may be part of more than one module.

As building functions become modernized, a unified control system capable of automatically monitoring various building equipment such as power equipment, lighting equipment, air conditioners, disaster prevention equipment, crime prevention equipment, and the like, may be employed. A facilities control system capable of integrally controlling this type of equipment may also be advantageous.

The unified control system must provide a common presentation in management interface for all of the devices and systems within any number of buildings or facilities. Accordingly, it must interface with all of the different communications protocols implemented by those different devices and systems, collecting data from numerous sources that are otherwise unable to intercommunicate, translating such data into a single format and providing the data to an end user in a uniform presentation form. Conversely, it must be able to receive input from a user in a uniform format and translate it into the specific data that conforms to the control protocols of the various devices and systems populating a facility.

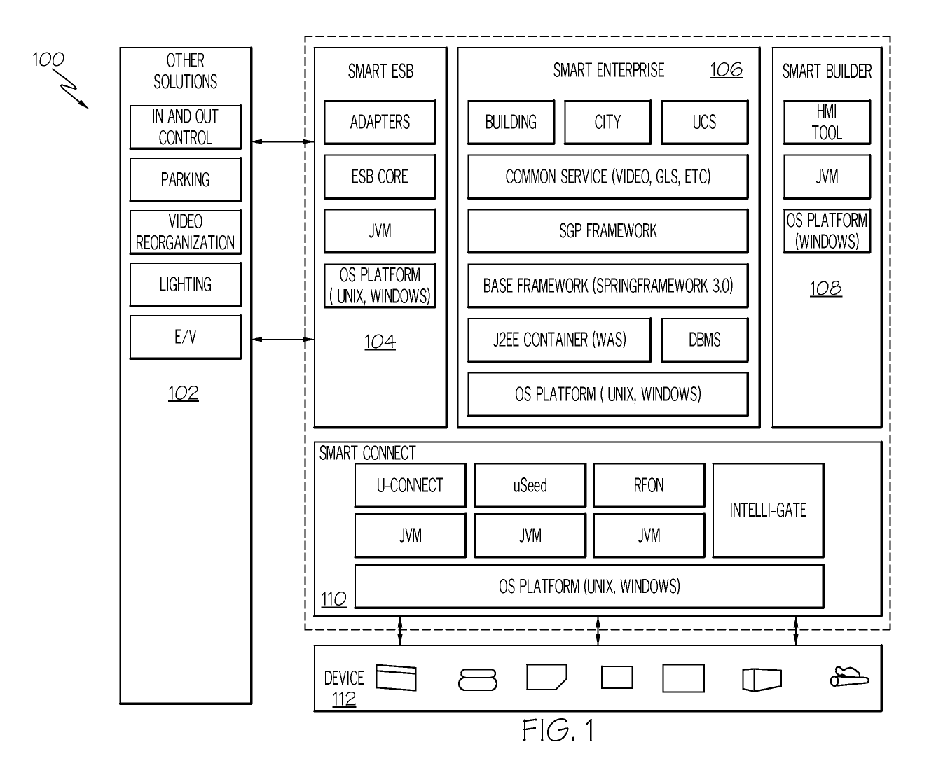

FIG. 1 shows an illustrative unified city building control system 100 in which various aspects of the invention may be implemented. The unified control system 100 may include Smart ESB 104, Smart Enterprise 106, Smart Builder 108 and Smart Connect 110. The unified control system 100 provides service to a customer under a system hub (e.g., Smart Enterprise 106). The unified control system may be implemented with communication protocols (e.g., Smart Connect 110) for controlling and/or monitoring facilities and equipment. An interface may be provided between humans and devices (e.g., Smart Builder 108). An enterprise service bus (ESB) may be implemented for communication and control of individual systems and/or outside systems (e.g., Smart ESB 104).

In one example, the Smart Enterprise 106 may be based on web application services (WAS) and a database management system (DBMS). Smart Connect 110 may work on a java virtual machine (JVM) and consist of U-Connect, uSeed, RFON, Intelli-Gate modules, or other middleware solutions. Smart Connect 110 may work between facilities and devices 112 (lower layer) and Smart Enterprise 106 (upper layer) for the monitoring and control. Smart Builder 108 works on the JVM client module and may consist of a graphic editor for a display device and a device interface module for monitoring and/or controlling one or more facilities. Smart ESB 104 manages the outside system connection. It controls the connection for many outside systems and sends the monitoring and control information. It may consist of an ESB core engine and adapters. The unified control system 100 may also provide one or more additional solutions 102, or the like.

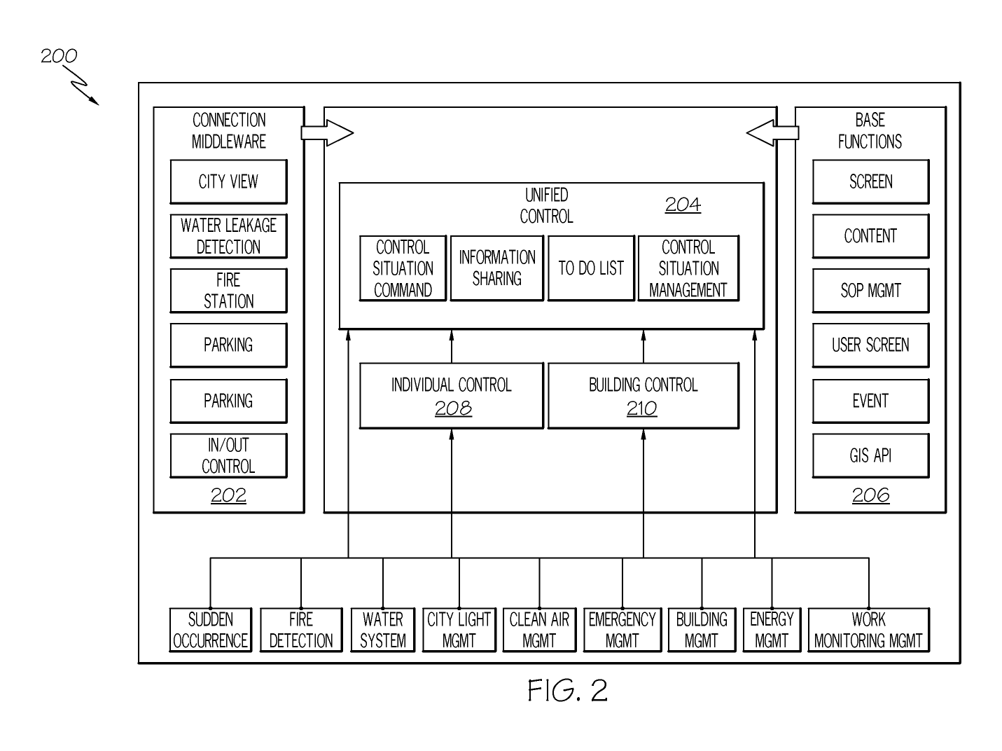

FIG. 2 shows a high-level diagram of an illustrative unified control system 200 in which various aspects of the invention may be implemented. The unified control system 200 may include connection middleware 202, unified control 204, base functions 206, individual control 208, and building control 210. Connection middleware 202 may provide connection protocols to one or more city build facilities. These may include, but are not limited to, a city view, water leakage detection, fire station, parking areas, and in/out building access.

Unified control 204 may provide individual control 208 and building control 210. Individual control 208 may provide monitoring and control information affecting an individual or group of individuals, but not necessarily related to a particular building or buildings. The information may relate to a sudden occurrence (i.e., single instance requirement attention), fire detection, water system, city light management, clean air management, and emergency management. Building control 210 may provide monitoring and control information related to a particular building or buildings. The information may relate to building management, energy management, and/or work monitoring management. The examples listed above are illustrative only and not intended to be limiting.

Base functions 206 may provide a control screen interface to a user for monitoring the information flow and controlling one or more facilities and/or buildings. In one example, the control screen may be customizable. All information may be shown in real-time. When an event occurs (e.g., fire detection), the event is indicated in real-time (push mode). When a map is used, a Globus Security Infrastructure (GIS) application programming interface (API) may be used.

The control screen may provide a common presentation in management interface for all of the devices and systems within a building or facility. Accordingly, it must interface with all of the different communications protocols implemented by those different devices and systems, collecting data from numerous sources that are otherwise unable to intercommunicate, translating such data into a single format, and providing the data to an end user in a uniform presentation form. Conversely, it must be able to receive input from a user in a uniform format and translate it into the specific data that conforms to the control protocols of the various devices and systems populating facility.

Base functions 206 may also assist in standard operating procedure (SOP) management. SOP management may be menu driven, allowing a user to receive the status information in real-time. Depending on a department function, the related SOP may be easily modified to the needs of the department. SOP information may be stored in the log file or database.

Current systems have different information technology (IT) systems for traffic, water management, clean air control, fire detection, etc. Therefore, a city or town must manage various management systems. The unified control system 200 maintains the consistency of the contents and the control method. This makes system upgrades to each of the functions easier and provides for consistent service throughout a community.

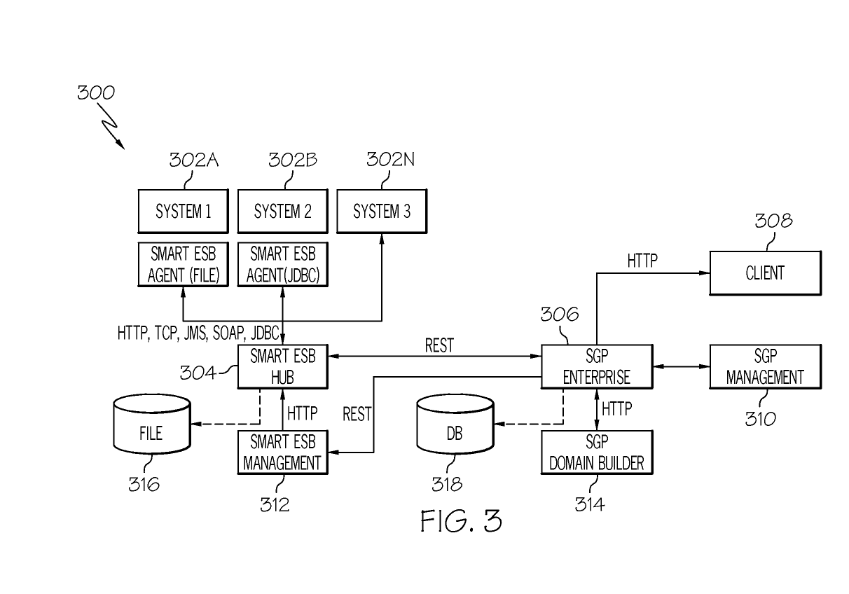

FIG. 3 shows an illustrative middleware module 300 (e.g., Smart ESB hub 304) operating with various components of the invention. Smart ESB hub 304 may communicate with one or more systems (e.g., System 1, 302A, System 2, 302B and System 3, 302N). A Smart ESB agent interface or outside interface may be used to bridge the connection(s) from the Smart ESP hub 304 and the system(s) 302A-N. In one example, various protocols including HTTP, TCP, JMS, SOAP, and/or IDBC may be used to interface with the system(s) 302A-N. In other examples, other protocols may be implemented. In addition, Smart ESB hub 304 may communicate with an SGP Enterprise 306. Smart Management 312 may perform the following functions: (1) controller and monitor, (2) message management, and (3) remote service stop. Smart ESB Agent (Adaptor) may perform the following functions: (1) file and database communication process, (2) service status monitoring, and (3) remote service stop interface process. SGP ESB hub 304 may communicate with Client 308, SGP Management 312, and SGP Domain Builder 314 via SGP Enterprise 306 standard (TAG Map) and (JAX-RS) interface node. Client 308 may provide a control screen interface to a user for monitoring the information flow and controlling one or more facilities and/or buildings.

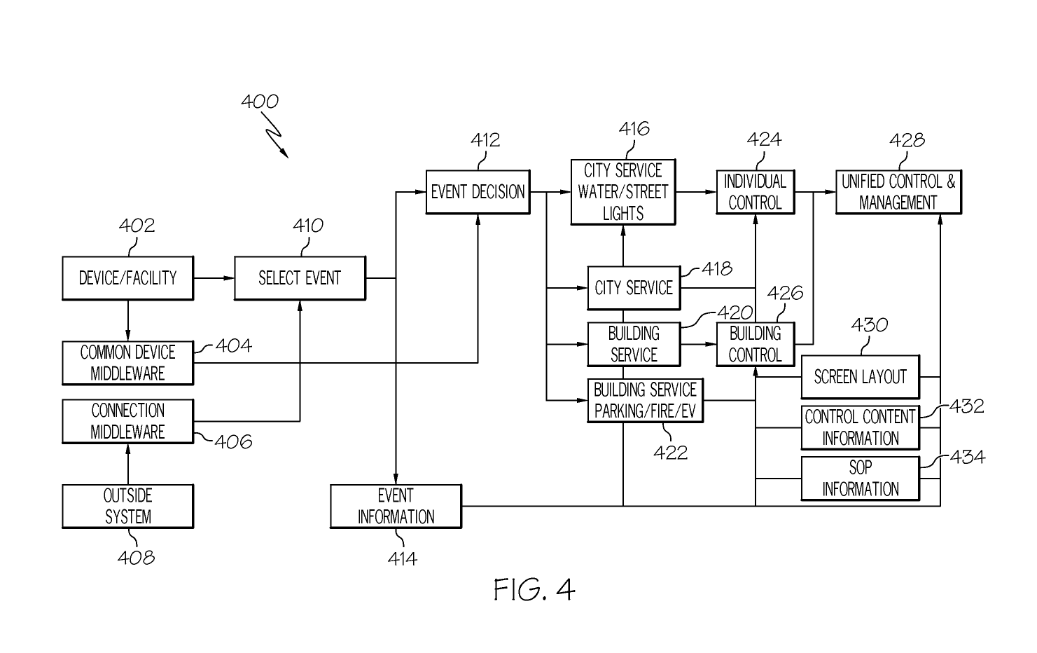

FIG. 4 shows a detailed graphical illustration according to an embodiment of the present invention showing a monitoring/controlling process 400. The system receives a measurement or status information from a device/facility 402 through a common device middleware 404 or an outside system connection middleware 406. An event processor selects an event 410 and receives event information 414. The event processor makes an event decision 412. A determination is made whether the information is within a normal range. The result of the determination is sent to the service. The service may include water or street lights 416, city service 418, building service 420, or building service parking/fire/EV 422. In one example, the event may be an on/off case and is not required to go through the event processor. In this case, the result is sent to the service directly. When the service receives the result, a service processor performs the service based on predefined logic. The event information may be pushed to a control screen in real time and displayed on a map indicating the area of the event. Screen layout 430 may include control content information 432 and SOP information 434. Individual control 424 and building control 426 is provided using a single unified control and management system.

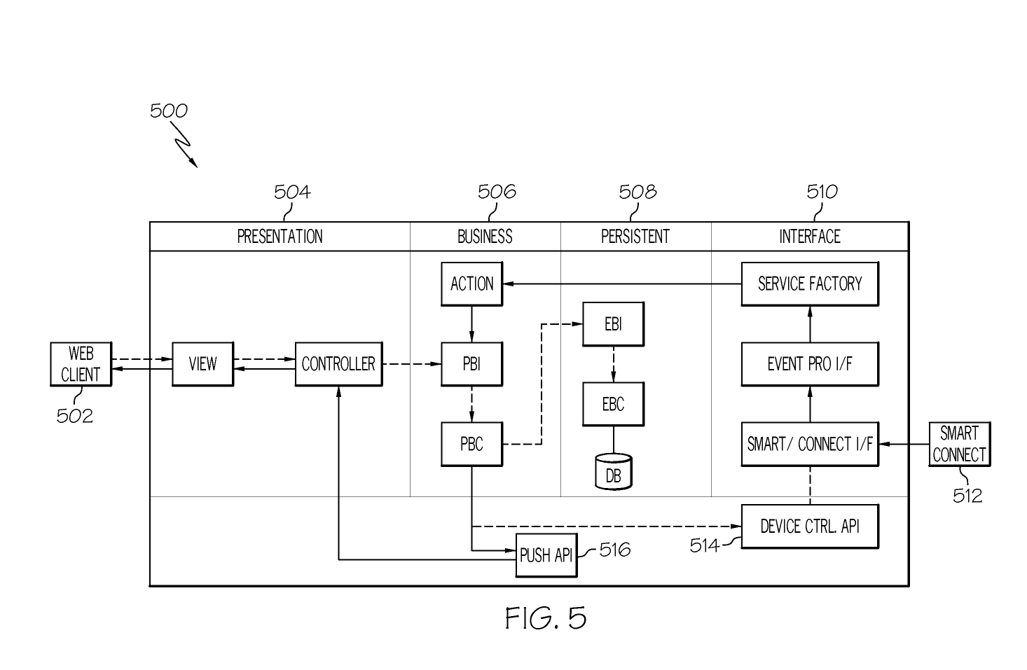

FIG. 5 shows four illustrative communications layers which provide information flow between a web client 502 and a communication module (e.g., Smart Connect 512). The system 500 comprises four layers including presentation 504, business 506, persistent 508 and interface 510. As described earlier, the service processor performs the service logic and displays the service result on a display screen, such as web client 502. When the event is determined to be a major event, the service processor may communicate this information to the unified control system.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

While shown and described herein as a integrated monitoring and controlling of building functions solution, it is understood that the invention further provides various alternative embodiments. For example, in one embodiment, the invention provides a computer-readable/useable medium that includes computer program code to enable a computer infrastructure to provide integrated monitoring and controlling of building functions functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.).

In another embodiment, the invention provides a computer-implemented method for integrated monitoring and controlling of building functions. In this case, a computer infrastructure can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for monitoring and controlling a plurality of site functionalities, comprising:
monitoring a first status of a first functionality at a first site;
monitoring a second status of a second functionality at a second site;
determining an event based on one of the first or second status;
determining a categorization of the event; and
performing a service in response to the categorization of the event.

2. The computer-implemented method of claim 1, wherein the first site is associated with at least one of a geographic location, facility, building, building structure, equipment, or equipment component.

3. The computer-implemented method of claim 1, wherein the step of determining an event comprises determining whether at least one of the first status or the second status is not within a predefined range.

4. The computer-implemented method of claim 1, further comprising displaying the first status on a display device in real-time to be used for standard operating procedure (SOP) management.

5. The computer-implemented method of claim 1, further comprising generating event information associated with the event and displaying the event information on a display device.

6. The computer-implemented method of claim 1, wherein the first functionality is associated with at least one of a sudden occurrence, a fire, a water leakage, a light management function, a clean air management function, or an emergency management function and the second functionality is associated with at least one of a building management function, an energy management function, or a work management function.

7. The computer-implemented method of claim 1, further comprising determining a first protocol associated with the first functionality and determining a second protocol associated with the second functionality, wherein the first protocol and second protocol are different.

8. A unified system for monitoring and controlling a plurality of site functionalities, comprising:
a monitoring module configured to monitor a first status of a first functionality at a first site;
the monitoring module further configured to monitor a second status of a second functionality at a second site;
an event module configured to determine an event based on one of the first or second status;
the event module further configured to determine a categorization of the event; and
a service module configured to perform a service in response to the categorization of the event.

9. The unified system of claim 8, the event module further configured to determine whether at least one of the first status or the second status is not within a predefined range.

10. The unified system of claim 8, further comprising a display device configured to display the first status in real-time to be used for standard operating procedure (SOP) management.

11. The unified system of claim 8, further comprising a display device configured to display event information associated with the event.

12. The unified system of claim 8, wherein the first functionality is associated with at least one of a sudden occurrence, a fire, a water leakage, a light management function, a clean air management function, or an emergency management function and the second functionality is associated with at least one of a building management function, an energy management function, or a work management function.

13. The unified system of claim 8, the monitoring module further configured to determine a first protocol associated with the first functionality and determine a second protocol associated with the second functionality, wherein the first protocol and second protocol are different.

14. The unified system of claim 13, wherein an outside system is monitored and controlled using an enterprise service bus.

15. A computer program product for monitoring and controlling a plurality of site functionalities, the computer program product comprising a computer readable storage media, and program instructions stored on the computer readable storage media, to:
monitor a first status of a first functionality at a first site;
monitor a second status of second functionality at a second site;
determine an event based on one of the first or second status;
determine a categorization of the event; and
perform a service in response to the categorization of the event.

16. The computer program product of claim 15, further comprising program instructions to determine whether at least one of the first status or the second status is not within a predefined range.

17. The computer program product of claim 15, further comprising program instructions to display the first status on a display device in real-time to be used for standard operating procedure (SOP) management.

18. The computer program product of claim 15, further comprising program instructions to generate event information associated with the event and display the event information on a display device.

19. The computer program product of claim 15, wherein the first functionality is associated with at least one of a sudden occurrence, a fire, a water leakage, a light management function, a clean air management function, or an emergency management function and the second functionality is associated with at least one of a building management function, an energy management function, or a work management function.

20. The computer program product of claim 15, further comprising program instructions to determine a first protocol associated with the first functionality and determine a second protocol associated with the second functionality, wherein the first protocol and second protocol are different.
